(19) United States
(12) Patent Application Publication
(10) Pub. No.: US 2008/0038052 A1
(43) Pub. Date: Feb. 14, 2008

(54) Adaptor for an Axle

(75) Inventors: Carsten Dalsgaard, Silkeborg (DK); Henrik Bondgaard, Risskov (DK)

Correspondence Address: ROBERTS, MLOTKOWSKI & HOBBES, P. O. BOX 10064, MCLEAN, VA, 22102-8064, US

(73) Assignee: MARTIN PROFESSIONAL A/S, Aarhus N (DK)

(21) Appl. No.: 11/813,824

(22) PCT Filed: Jan. 13, 2006
(86) PCT No.: PCT/DK06/00023

§ 371 Date: Jul. 23, 2007

(30) Foreign Application Priority Data
Jan. 13, 2005 (DK) PA 2005 00069

(51) Int. Cl. F16D 1/08

(52) U.S. Cl. 403/344; 403/362

(57) ABSTRACT

An adaptor (8) for an axle where the axle defines the centre of rotation for transmission of the rotational movement to at least one access or attachment point (6), which is eccentric with the axis of rotation, where the adaptor (8) is disc-shape with an outer perimeter (7) and an inner perimeter (9), where the inner perimeter (9) has a shape which fits the axle, and furthermore where the adaptor (8) includes securing means for securing the adaptor (8) to the axle. This adaptor (8) is distinctive by a cut-out (10) connects the inner perimeter (9) with the outer perimeter (7), and the securing means consist of a shank portion (15) and a tread portion (14) where the shank portion (15) is larger than the tread portion (14). Hereby reducing the permanent deformation of the adaptor (8) as well as the axle as the shank portion (15) will provide most of the elasticity for the clamping force rendering it possible to transmit torque as well as reduce angle deformation.

### FIELD OF THE INVENTION

The present invention relates to an adaptor for an axle, where the axle defines the centre of rotation for transmission of the rotational movement to at least one access or attachment point, which is eccentric with the axis of rotation, where the adaptor is disc-shape with an outer perimeter and an inner perimeter, where the inner perimeter has a shape which fits the axle. Furthermore, the adaptor includes securing means for securing the adaptor to the axle.

### BACKGROUND OF THE INVENTION

In lighting arrangements or fixtures, you often need to fasten an adaptor to an axle mechanically. A common way of doing this is by forcing a set screw mounted on the adaptor into the axle. However, this causes a number of difficulties. The set screw among others creates burrs in the axle. These burrs will make it difficult to remove the adaptor or even rotate it some degrees if it is needed in connection with adjustment.

A way to avoid the burrs is to create a squeeze adaptor to overcome the before-mentioned drawbacks. This could be an adaptor made from alloy such as die caste zinc. Instead of forcing a set screw into the axle, a normal screw is used to apply a clamping or squeezing force around the axle and in this way avoid any burrs on the axle. This kind of adaptor works except for two things. First, it was very sensitive to the amount of torque needed to fasten the screw. If the amount of torque is too little, it would not clamp, and if the amount of torque is too high, it would cause a permanent deformation or cracking of the adaptor. Second, it has reduced clamping force over time. The actual reasons are partly due to the material and partly due to the design. If exposed to high temperatures and tension forces, zinc will creep over time. The design with a slot on each side of the axle makes it even worse. When tightening the screw, the slot would become narrower on the screw side, but, unfortunately, it would also become wider on the opposite side. This causes another drawback as the rivet holes “moves” angularly up towards the screw. These problems are further enhanced as most of the parts attached to this adaptor are both glued and riveted and can, therefore, not accept this movement or deformation.

JP05001720 concerns a shaft joint where the purpose is to provide such that its attachment/detachment and positioning are carried out easily on a shaft. The shaft joint comprises a bolt for penetrating through a slit of a flange. This bolt is composed of a large diameter part on its head side, a male screw part on its top end side and a small diameter part put in connection there between. This large diameter part is loosely inserted into a slitted piece and the male screw part is screwed into a female screw provided on a slitted piece and a stop ring is loosely fitted in the slit in the small diameter part.

The bolt is placed close to the outer periphery of the axel hole. For connecting the shaft joint a high force has to be generated but the bolt has a small diameter, which diameter is too small for the force necessary to connect the shaft joint to an axle.

### OBJECT OF THE INVENTION

The object of the invention is to provide an adaptor for an axle, where mechanical fixing—torque as well as angle—may be possible without permanent deformation of the adaptor as well as the axle. Furthermore, it is the object of the invention to avoid creating burrs in the axle from set screws or similar fastening elements. Yet further, it will be advantageous if the shank portion of the adaptor is positioned as far away from the access or attachment points as possible. Permanent and elastic deformation will be a part of fastening an adaptor; it will be advantageous if the elastic part is greater than the permanent or static part.

### DESCRIPTION OF THE INVENTION

The present invention provides an adaptor for an axle where the axle defines the centre of rotation for transmission of the rotational movement to at least one access or attachment point, which is eccentric with the axis of rotation, where the adaptor is disc-shape with an outer perimeter and an inner perimeter, where the inner perimeter has a shape which fits the axle, and furthermore where the adaptor includes securing means for securing the adaptor to the axle. This adaptor is distinctive in that a cut-out connects the inner perimeter with the outer perimeter, and the securing means consist of a shank portion and a tread portion where the shank portion is larger than the tread portion, hereby, reducing the permanent deformation of the adaptor as well as the axle as the shank portion will provide most of the elasticity for the clamping force and thereby render it possible to transmit torque as well as reduce angle deformation.

According to the invention, the cut-out ends as a tangent to the inner perimeter. This reduces and may even avoid the deformation leading to burrs in the surface of the axle, and furthermore no set screw will have to penetrate the axle.

Furthermore, according to the invention, the securing means comprise a screw, a tread, a shank and the cut-out. All these elements will contribute to the elasticity for the sufficient clamping force, so that the mechanical fixing will be more precise.

Yet further according to the invention, the shank portion of the screw is positioned on one side of the cut-out, and the tread portion of the screw is positioned on the other side of the cut-out, and the length of the shank portion is larger than the length of the tread portion, preferably between 10% and 50% and most preferably more than 20%. By increasing the shank portion positioned distant to the access or attachment point sufficient torque and less angle variation can be reached.

It has shown advantageous that the screw, when the adaptor is mounted on the axle, is positioned inside the outer perimeter and outside the inner perimeter, and that the axis of the screw crosses the cut-out.

Furthermore, according to the invention, the cut-out can be provided as a cut track, a slot in the adaptor or a moulded or forged weakening line in the adaptor, where the adaptor is made from an aluminium alloy. This has shown advantageous from a production point of view.

According to the invention, the centre hole can be designed larger than the axle allowing tolerance with a diameter difference of up to 0.03 mm. This is possible as the cut-out will not create burrs in the axle even with a large deformation.

### DESCRIPTION OF THE DRAWING

The invention is described in details referring to the drawing, where

FIG. 1 shows an adaptor positioned on a motor, and

FIG. 2 shows further details of an adaptor.

### DETAILED DESCRIPTION OF THE INVENTION

The adaptor 8 has been designed in order to address the problems discovered with the zinc item. The design is made with only one cut-out 10 or slot on the screw side of the centre hole 9 being the inner perimeter of the adaptor 8, and because it is made from aluminium or an aluminium alloy rather than zinc, it is less prone to creep.

The ability to maintain a clamping force on this type of adaptor relays very much to the tension you can build up in the screw 11. This again is relative to the free length of the screw 11 (the distance between the head of the screw 11, and where the thread fastens into a nut, part etc.), and the cut-out 10 or slot is, therefore, made in an angle to maximise this length.

The new design is more tolerant when it comes to the mounting torque applied to the screw 11. In fact when mounted on an axle you can tighten the screw on the new adaptor so much that the screw is destroyed before it can damage the adaptor.

The part 12 between the two rivet holes on the opposite side of the screw 11 is made massive to minimize angular hole movement as seen on the zinc item.

Another detail which is also present at the zinc item is that the screw head is kept within the outside diameter of the adaptor.

The adaptor can be used for a step motor, an ordinary AC or DC motor, a hydraulic motor and even for linear motors of the same type. The adaptor can be used for other kind of fastening as well.

When used for a motor having an axle with a defined centre of rotation, it is usually used for transmitting rotational movement to at least one access or attachment point eccentric with the axis of rotation. These access or attachment points may be needed for anchorage to another mechanical construction.

The adaptor is disc-shaped with an outer perimeter and an inner perimeter, and the inner perimeter has a shape to fit the rotational axle of the motor. This has been chosen as most of the appliances are step motors for movable lighting arrangements.

The adaptor includes securing means for securing the adaptor to the axle of rotation. These securing means could be other than a screw, but a screw used in this situation is more serviceable with ordinary hand tools. Permanent securing means like a rivet could introduce difficulties in connection with service or adjustment.

The securing means comprise a screw, a tread and a cut-out. The cut-out connects the inner perimeter with the outer perimeter. The cut-out ends as a tangent to the inner perimeter. As the cut-out ends as tangent to the inner perimeter or the inner hole, even large deformations due to fastening the screw will not introduce burrs in the surface of the axle inserted in the hole.

The screw when the adaptor is mounted on the axle is positioned within the outer perimeter and outside the inner perimeter. The screw as well as the adaptor can then be closer to dynamic balance. This is most important with high-speed rotation and large acceleration forces.

The axis of the screw crosses the cut-out. Otherwise, the screw would not contribute to the clamping force. The cut-out is across the hole for the screw and tangential to the hole for the axle.

The screw has a treaded portion and a shank portion. The shank portion of the hole and the screw are positioned on one side of the adaptor, the tread portion of the hole and screw are positioned in the opposite side of adaptor, and the sides of the adaptor are defined by the cut-out to accept the screw head.

The shank portion of the adaptor is larger than the tread portion of the adaptor. This introduces more elasticity in this area.

The axis of the screw is perpendicular to the axes of rotation of the motor to introduce the largest securing force.

The inner perimeter or the hole can be circular, angular or splined. This opens the possibility of fastening or securing to different axles.

The adaptor is a pulley or base part of a pulley or other construction element.

The cut-out is cut, moulded or procured as a weakening line in the adaptor.

The invention is not limited to the shown embodiments but may be modified by a man skilled in the art within the scope of the following claims.

### FIELD OF THE INVENTION

The present invention relates to an adaptor for an axle, where the axle defines the centre of rotation for transmission of the rotational movement to at least one access or attachment point, which is eccentric with the axis of rotation, where the adaptor is disc-shape with an outer perimeter and an inner perimeter, where the inner perimeter has a shape which fits the axle. Furthermore, the adaptor includes securing means for securing the adaptor to the axle.

### BACKGROUND OF THE INVENTION

In lighting arrangements or fixtures, you often need to fasten an adaptor to an axle mechanically. A common way of doing this is by forcing a set screw mounted on the adaptor into the axle. However, this causes a number of difficulties. The set screw among others creates burrs in the axle. These burrs will make it difficult to remove the adaptor or even rotate it some degrees if it is needed in connection with adjustment.

A way to avoid the burrs is to create a squeeze adaptor to overcome the before-mentioned drawbacks. This could be an adaptor made from alloy such as die caste zinc. Instead of forcing a set screw into the axle, a normal screw is used to apply a clamping or squeezing force around the axle and in this way avoid any burrs on the axle. This kind of adaptor works except for two things. First, it was very sensitive to the amount of torque needed to fasten the screw. If the amount of torque is too little, it would not clamp, and if the amount of torque is too high, it would cause a permanent deformation or cracking of the adaptor. Second, it has reduced clamping force over time. The actual reasons are partly due to the material and partly due to the design. If exposed to high temperatures and tension forces, zinc will creep over time. The design with a slot on each side of the axle makes it even worse. When tightening the screw, the slot would become narrower on the screw side, but, unfortunately, it would also become wider on the opposite side. This causes another drawback as the rivet holes “moves” angularly up towards the screw. These problems are further enhanced as most of the parts attached to this adaptor are both glued and riveted and can, therefore, not accept this movement or deformation.

JP05001720 concerns a shaft joint where the purpose is to provide such that its attachment/detachment and positioning are carried out easily on a shaft. The shaft joint comprises a bolt for penetrating through a slit of a flange. This bolt is composed of a large diameter part on its head side, a male screw part on its top end side and a small diameter part put in connection there between. This large diameter part is loosely inserted into a slitted piece and the male screw part is screwed into a female screw provided on a slitted piece and a stop ring is loosely fitted in the slit in the small diameter part.

The bolt is placed close to the outer periphery of the axel hole. For connecting the shaft joint a high force has to be generated but the bolt has a small diameter, which diameter is too small for the force necessary to connect the shaft joint to an axle.

### OBJECT OF THE INVENTION

The object of the invention is to provide an adaptor for an axle, where mechanical fixing—torque as well as angle—may be possible without permanent deformation of the adaptor as well as the axle. Furthermore, it is the object of the invention to avoid creating burrs in the axle from set screws or similar fastening elements. Yet further, it will be advantageous if the shank portion of the adaptor is positioned as far away from the access or attachment points as possible. Permanent and elastic deformation will be a part of fastening an adaptor; it will be advantageous if the elastic part is greater than the permanent or static part.

### DESCRIPTION OF THE INVENTION

The present invention provides an adaptor for an axle where the axle defines the centre of rotation for transmission of the rotational movement to at least one access or attachment point, which is eccentric with the axis of rotation, where the adaptor is disc-shape with an outer perimeter and an inner perimeter, where the inner perimeter has a shape which fits the axle, and furthermore where the adaptor includes securing means for securing the adaptor to the axle. This adaptor is distinctive in that a cut-out connects the inner perimeter with the outer perimeter, and the securing means consist of a shank portion and a tread portion where the shank portion is larger than the tread portion, hereby, reducing the permanent defornmation of the adaptor as well as the axle as the shank portion will provide most of the elasticity for the clamping force and thereby render it possible to transmit torque as well as reduce angle defornmation.

According to the invention, the cut-out ends as a tangent to the inner perimeter. This reduces and may even avoid the defornmation leading to burrs in the surface of the axle, and furthermore no set screw will have to penetrate the axle.

Furthermore, according to the invention, the securing means comprise a screw, a tread, a shank and the cut-out. All these elements will contribute to the elasticity for the sufficient clamping force, so that the mechanical fixing will be more precise.

Yet further according to the invention, the shank portion of the screw is positioned on one side of the cut-out, and the tread portion of the screw is positioned on the other side of the cut-out, and the length of the shank portion is larger than the length of the tread portion, preferably between 10% and 50% and most preferably more than 20%. By increasing the shank portion positioned distant to the access or attachment point sufficient torque and less angle variation can be reached.

It has shown advantageous that the screw, when the adaptor is mounted on the axle, is positioned inside the outer perimeter and outside the inner perimeter, and that the axis of the screw crosses the cut-out.

Furthermore, according to the invention, the cut-out can be provided as a cut track, a slot in the adaptor or a moulded or forged weakening line in the adaptor, where the adaptor is made from an aluminium alloy. This has shown advantageous from a production point of view.

According to the invention, the centre hole can be designed larger than the axle allowing tolerance with a diameter difference of up to 0.03 mm. This is possible as the cut-out will not create burrs in the axle even with a large deformation.

### DESCRIPTION OF THE DRAWING

The invention is described in details referring to the drawing, where

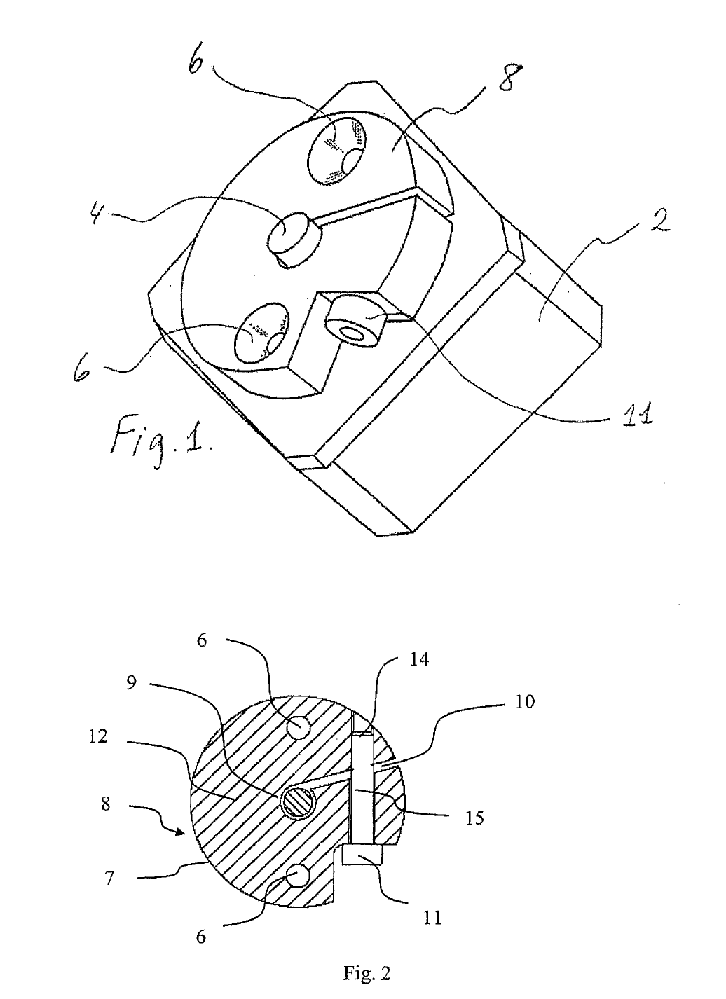

FIG. 1 shows an adaptor positioned on a motor, and

FIG. 2 shows further details of an adaptor.

### DETAILED DESCRIPTION OF THE INVENTION

The adaptor 8 has been designed in order to address the problems discovered with the zinc item. The design is made with only one cut-out 10 or slot on the screw side of the centre hole 9 being the inner perimeter of the adaptor 8, and because it is made from aluminium or an aluminium alloy rather than zinc, it is less prone to creep.

The ability to maintain a clamping force on this type of adaptor relays very much to the tension you can build up in the screw 11. This again is relative to the free length of the screw 11 (the distance between the head of the screw 11, and where the thread fastens into a nut, part etc.), and the cut-out 10 or slot is, therefore, made in an angle to maximise this length.

The new design is more tolerant when it comes to the mounting torque applied to the screw 11. In fact when mounted on an axle you can tighten the screw on the new adaptor so much that the screw is destroyed before it can damage the adaptor.

The part 12 between the two rivet holes on the opposite side of the screw 11 is made massive to minimize angular hole movement as seen on the zinc item.

Another detail which is also present at the zinc item is that the screw head is kept within the outside diameter of the adaptor.

The adaptor can be used for a step motor, an ordinary AC or DC motor, a hydraulic motor and even for linear motors of the same type. The adaptor can be used for other kind of fastening as well.

When used for a motor having an axle with a defined centre of rotation, it is usually used for transmitting rotational movement to at least one access or attachment point eccentric with the axis of rotation. These access or attachment points may be needed for anchorage to another mechanical construction.

The adaptor is disc-shaped with an outer perimeter and an inner perimeter, and the inner perimeter has a shape to fit the rotational axle of the motor. This has been chosen as most of the appliances are step motors for movable lighting arrangements.

The adaptor includes securing means for securing the adaptor to the axle of rotation. These securing means could be other than a screw, but a screw used in this situation is more serviceable with ordinary hand tools. Permanent securing means like a rivet could introduce difficulties in connection with service or adjustment.

The securing means comprise a screw, a tread and a cut-out. The cut-out connects the inner perimeter with the outer perimeter. The cut-out ends as a tangent to the inner perimeter. As the cut-out ends as tangent to the inner perimeter or the inner hole, even large deformations due to fastening the screw will not introduce burrs in the surface of the axle inserted in the hole.

The screw when the adaptor is mounted on the axle is positioned within the outer perimeter and outside the inner perimeter. The screw as well as the adaptor can then be closer to dynamic balance. This is most important with high-speed rotation and large acceleration forces.

The axis of the screw crosses the cut-out. Otherwise, the screw would not contribute to the clamping force. The cut-out is across the hole for the screw and tangential to the hole for the axle.

The screw has a treaded portion and a shank portion. The shank portion of the hole and the screw are positioned on one side of the adaptor, the tread portion of the hole and screw are positioned in the opposite side of adaptor, and the sides of the adaptor are defined by the cut-out to accept the screw head.

The shank portion of the adaptor is larger than the tread portion of the adaptor. This introduces more elasticity in this area.

The axis of the screw is perpendicular to the axes of rotation of the motor to introduce the largest securing force.

The inner perimeter or the hole can be circular, angular or splined. This opens the possibility of fastening or securing to different axles.

The adaptor is a pulley or base part of a pulley or other construction element.

The cut-out is cut, moulded or procured as a weakening line in the adaptor.

The invention is not limited to the shown embodiments but may be modified by a man skilled in the art within the scope of the following claims.

1-6. (canceled)

7. Adaptor for an axle where the axle defines the centre of rotation for transmission of the rotational movement to at least one access or attachment point which is eccentric with the axis of rotation, where the adaptor is disc-shape with an outer perimeter and an inner perimeter, where the inner perimeter has a shape which fits the axle, and furthermore where the adaptor includes securing means for securing the adaptor to the axle, wherein a cut-out connects the inner perimeter with the outer perimeter, and the securing means consist of a shank portion and a tread portion where the shank portion is larger than the tread portion, where the cut-out ends as a tangent to the inner perimeter.

8. Adaptor according to claim 7, wherein the securing means comprise a screw, a tread, a shank and the cut-out.

9. Adaptor according to claim 8, wherein the shank portion of the screw is positioned on one side of the cut-out, and that the tread portion of the screw is positioned on the other side of the cut-out, and wherein the length of the shank portion is larger than the length of the tread portion, preferably between 10% and 50% and most preferably more than 20%.

10. Adaptor according to claim 8, wherein the screw when the adaptor is mounted on the axle is positioned inside the outer perimeter and outside the inner perimeter, and that the axis of the screw crosses the cut-out.

11. Adaptor according to claim 7, wherein the cut-out is provided as a cut track, a slot in the adaptor or a moulded or forged weakening line in the adaptor, and wherein the adaptor is made from an aluminium alloy.

12. Adaptor according to claim 7, wherein a centre hole is designed larger than the axle allowing tolerance with diameter difference up to 0.03 mm.
